(19) United States
(12) Patent Application Publication
(10) Pub. No.: US 2006/0018044 A1
(43) Pub. Date: Jan. 26, 2006

(54) Objective lens actuator with improved resonance frequency

(75) Inventor: Johannes Van Rooij, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTROINCS N.V., EINDHOVEN (NL)

(21) Appl. No.: 10/527,118

(22) PCT Filed: Sep. 10, 2003
(86) PCT No.: PCT/IB03/04015

§ 371 Date: Mar. 8, 2005

(30) Foreign Application Priority Data
Sep. 25, 2002 (EP) 02292354.4

(51) Int. Cl. G02B 7/02

(52) U.S. Cl. 359/824

(57) ABSTRACT

The present invention relates to an objective lens actuator comprising a lens holder (10), a first pair of first coil carriers (13,23) fixed on opposite sides of the lens holder, and a second pair of second coil carriers (15,25) adjacent to said first pair and fixed on opposite sides of the lens holder. Said actuator further comprises tension wires (20,21), a tension wire being fixed between the coil carriers of a pair. Use: DVD player/recorder.

### FIELD OF THE INVENTION

The present invention relates to an objective lens actuator comprising a lens holder, a first pair of first coil carriers fixed on opposite sides of the lens holder, and a second pair of second coil carriers, adjacent to said first pair and fixed on opposite sides of the lens holder.

This invention is particularly relevant for optical recording and reproducing systems requiring high bandwidth.

### BACKGROUND OF THE INVENTION

Conventional two-dimensional (2-D) optical system lens actuators, which are able to perform focus and radial disc tracking, have a head resonance frequency around 15 kHz, resulting in a maximum bandwidth of 3 to 6 kHz.

Based on the structure of 2-D actuators, new three-dimensional (3-D) lens actuators, which are able to perform tilt correction in addition to the two above-cited features, have a head resonance of 11 kHz, resulting in a low bandwidth of the optical system in which they are included.

### SUMMARY OF THE INVENTION

It is an object of the invention to propose an objective lens actuator with a higher bandwidth.

To this end, the objective lens actuator in accordance with the invention comprises tension wires, a tension wire being fixed between the coil carriers of a pair.

The tension wires placed inside the lens holder are adapted to rigidify the objective lens actuator. As a result, the actuator head resonance is increased as well as the bandwidth of the optical system comprising said actuator.

The objective lens actuator in accordance with the invention can be included in a recording and/or reproducing system, such as a DVD recorder or a DVD player for example, for recording on and/or reproducing from a record carrier.

These and other aspects of the invention will be apparent from and will be elucidated with reference to the embodiments described hereinafter.

### BRIEF DESCRIPTION OF THE DRAWINGS

The present invention will now be described in more detail, by way of example, with reference to the accompanying drawings, wherein:

FIG. 1 is a 3-D representation of a conventional implementation of a 3-D actuator,

FIG. 2 is a 3-D representation of a 3-D actuator in accordance with the invention, and

FIG. 3 shows the frequency response of said 3-D actuator.

### DETAILED DESCRIPTION OF THE INVENTION

The present invention relates to an objective lens actuator. This objective lens actuator can be a two-dimensional (2-D) actuator, comprising radial coils for moving the objective lens in a radial direction and focus coils for moving the objective lens in a focal direction.

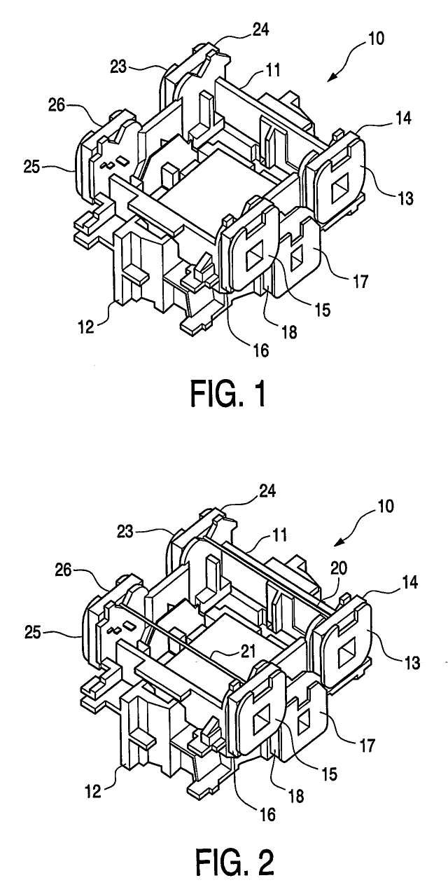

In the preferred embodiment, the objective lens actuator is a three-dimensional (3-D) actuator. Said 3-D actuator is depicted in FIG. 1 and comprises a lens holder (10), for example made of plastic material. Said lens holder is constituted of two parts (11,12) attached to each other, the section of each part being substantially rectangular. The lens holder (10) is able to hold an objective lens, which is positioned below the lower part (12), said lens not being represented in FIG. 1.

The upper part (11) of the lens holder comprises a first pair of coil carriers (13,23) fixed on opposite sides of said upper part. A coil carrier (13,23) of the first pair is able to carry a first coil (14,24), which is rolled around said carrier. The first coil (14,24) is used for moving the objective lens in a first direction. In the preferred embodiment, said first coil (14,24) is a focus coil used for moving the objective lens in a focal direction.

The upper part (11) of the lens holder also comprises a second pair of coil carriers (15,25) fixed on opposite sides of said upper part. A coil carrier of the first pair (13 or 23) is adjacent to a coil carrier of the second pair (15 or 25), said coil carriers being positioned on the same side of the rectangular section. A coil carrier (15,25) of the second pair is able to carry a second coil (16,26), which is rolled around said carrier. The second coil (16,26) is used for moving the objective lens in a second direction. In the preferred embodiment, said second coil (16,26) is a tilt coil dedicated to a tilt correction, that is to say a correction of a tilt around an uncontrolled actuator translation.

The lower part (12) of the lens holder also comprises a third pair of coil carriers (only one coil carrier (17) of said pair being represented in FIG. 1) fixed on opposite sides of said lower part. A coil carrier of the third pair (17) is positioned on the same side of the rectangular section as a coil carrier of the first (13) and second (15) pairs. A coil carrier (17) of the third pair is able to carry a third coil (18), which is rolled around said carrier. The third coil (18) is used for moving the objective lens in a third direction. In the preferred embodiment, said third coil (18) is a radial coil used for moving the objective lens in a radial direction.

With such a structure, the 3-D actuator has a resonance frequency of about 11 kHz, resulting in a poor bandwidth of the optical system comprising said actuator.

In order to cope with this problem, FIG. 2 shows a 3-D actuator in accordance with the invention. In addition to the above-described characteristics, the 3-D actuator comprises tension wires (20,21), a first tension wire (20) being fixed between the coil carriers (13,23) of a first pair and second tension wire (21) being fixed between the coil carriers (15,25) of a second pair.

In the preferred embodiment, the tension wires are substantially perpendicular to the coil carriers and are fixed on top of a median axis of the coil carriers. By virtue thereof a better performance in terms of an increase of the 3-D actuator resonance frequency is achieved.

In the preferred embodiment, the tension wires are made of beryllium-copper and are about 140 mm thick and 7 mm long. Thus, the mass of the tension wires is about 2 mg, that is to say about 10% of the mass of the lens holder and only about 1% of the total mass of the actuator. By using such tension wires, it is possible to make a very lightweight lens holder resulting in a higher power efficiency of the optical system comprising the 3-D actuator, and thus in low power needs and less heating of the lens.

Note that in the case of a 2-D actuator, the lens holder comprises only two pairs of coil carriers, said two pairs being fixed on the upper part of the lens holder and being adjacent to each other. The first coils mounted on the first pair of coil carriers are focus coils whereas the second coils mounted on the second pair of coil carriers are radial coils.

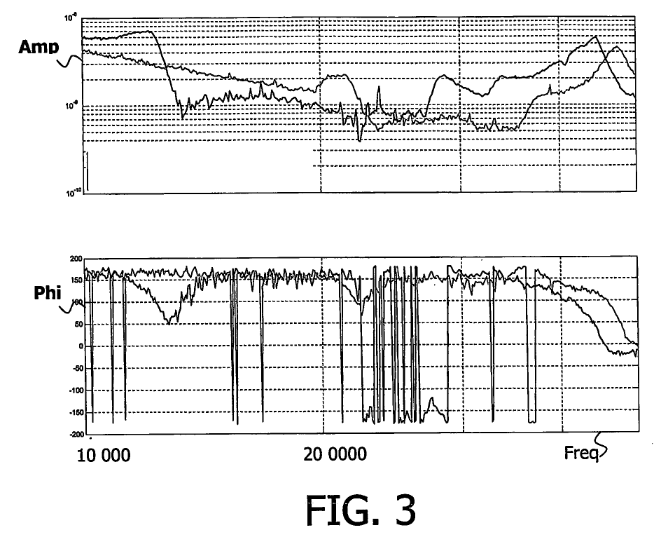

FIG. 3 shows the frequency response of the 3-D actuator in accordance with the invention. It represents the measured focus frequency response curve, that is to say the ratio of the velocity of the objective lens in the focus direction to the focussing force in terms of amplitude (Amp) and phase (Phi) as a function of the frequency (Freq). The grey line represents the improved 3-D actuator response whereas the black line represents the conventional 3-D actuator response. It can be seen that the resonance frequency has increased from 11 kHz to 21 kHz. As a result, the bandwidth of the optical system comprising said actuator is increased up to 7 kHz.

Any reference sign in the following claims should not be construed as limiting the claim. It will be obvious that the use of the verb “to comprise” and its conjugations does not exclude the presence of any other steps or elements besides those defined in any claim. The word “a” or “an” preceding an element or step does not exclude the presence of a plurality of such elements or steps.

1. An objective lens actuator comprising a lens holder (10), a first pair of first coil carriers (13,23) fixed on opposite sides of the lens holder, a first coil (14,24) being used for moving an objective lens in a first direction, and a second pair of second coil carriers (15,25) adjacent to said first pair and fixed on opposite sides of the lens holder, a second coil (16,26) being used for moving the objective lens in a second direction, said actuator being characterized in that it further comprises tension wires (20,21), a tension wire being fixed between the coil carriers of a pair.

2. An objective lens actuator as claimed in claim 1, wherein the tension wires are substantially perpendicular to the coil carriers and are fixed on a median axis of said coil carriers.

3. An objective lens actuator as claimed in claim 1, wherein the tension wires are made of beryllium-copper.

4. A recording and/or reproducing system comprising an objective lens actuator as claimed in claim 1, for recording on and/or reproducing from a record carrier.
